(19) United States
(12) Patent Application Publication
(10) Pub. No.: US 2004/0103133 A1
(43) Pub. Date: May 27, 2004

(54) Decimating filter

(75) Inventor: Paul Thomas Gurney, Burnaby (CA)

Correspondence Address: Peter Van Baarsen, 200-2700 Production Way, Burnaby, BC, V5A 4X1, CA

(73) Assignee: Spectrum Signal Processing Inc., Burnaby (CA)

(21) Appl. No.: 10/304,680

(22) Filed: Nov. 27, 2002

(51) Int. Cl. G06F 17/17

(52) U.S. Cl. 708/313

(57) ABSTRACT

If there are N inputs into a decimate-by-M filter, a plurality (N/M) of decimate-by-N sub-filters is configured in parallel. Each decimation sub-filter outputs one sample, resulting in an aggregate of (N/M) output samples per processing cycle. The inputs to each sub-filter should be out of phase by M samples.

### FIELD OF THE INVENTION

This invention relates to wideband signal processing.

### BACKGROUND OF THE INVENTION

A decimator takes as input a stream of samples at a certain sample rate and outputs a stream of samples at a lower sample rate. The decimator typically includes a filter which removes energy contained in the frequencies above the Nyquist frequency (Fs/2) of the output sample rate.

Analog to Digital Converters (ADCs) provide the input stream of samples to the decimator. The sample rate of this stream can be several times the maximum processing clock speed of a hardware implementation of a filter. For example, an ADC could provide a stream at a sample rate of 800 million samples per second, whereas a hardware implementation of a filter may only have a processing clock speed of 200 million cycles per second.

Prior art decimating filters include many variants on the single-output sample per processing cycle. In contrast, this invention provides a decimating filter structure that features multiple output samples to be generated on each processing clock cycle by the parallel use of multiple sub-filters, and thus permits the hardware speed limitations of any single sub-filter to be obviated.

### SUMMARY OF THE INVENTION

Suppose that an “N inputs into a decimate-by-M” filter is desired where the clock speed of the filter is insufficient to process the input sample rate. For example, it is desired to reduce the sample rate by a factor of 2 (4 input samples per cycle and 2 output samples per cycle—see FIG. 1). This invention involves the implementation of a plurality (N/M) of decimate-by-N sub-filters along the following lines. Each decimation sub-filter outputs one sample, resulting in an aggregate of (N/M) output samples per processing cycle. The inputs to each sub-filter should be out of phase by M samples. For example, with 4 inputs into a decimate-by-2 filter, there will be 2 decimate-by-4 sub-filters and the inputs to each sub-filter need to be out of phase by 2 samples, as shown in FIG. 2. The effect of this invention is the output sample rates may be higher than the processing speed of processing clock rate of the filter (i.e. higher than any single sub-filter thereof).

According to this invention, there is provided a method of multiple input-multiple output digital filtering though decimate-by-M decimation comprising the steps of: (a) providing in parallel, a plurality of (N/M) decimate-by-N sub-filters; and (b) staggering the inputs to each said sub-filter to be out of phase by M samples, where N is a multiple of M.

### BRIEF DESCRIPTION OF THE DRAWINGS

A better understanding of the present invention can be obtained when the following detailed description of the preferred embodiment is considered in conjunction with the following drawings, in which:

FIG. 1 shows a decimating filter accepting 4 input samples and generating 2 output samples on every clock cycle;

FIG. 2 shows the implementation according to this invention, of the filter in FIG. 1, consisting of two decimate-by-4 filters, with inputs which are 2 samples out of phase;

FIG. 3 shows the frequency spectrum of a signal which is input to the DDC;

FIG. 4 shows the frequency spectrum after shifting to baseband;

FIG. 5 shows a simple direct-form FIR filter;

FIG. 6 shows a simple transpose-form FIR filter;

FIG. 7 shows a filter running at the output rate;

FIG. 8 shows a decimating direct-form FIR filter;

FIG. 9 shows a decimating transpose-form FIR filter;

FIG. 10 shows a MIMO decimating filter;

FIG. 11 shows an implementation of the MIMO decimating filter of FIG. 10;

FIG. 12 shows staggered inputs to MIMO decimating filter of FIG. 11;

FIG. 13 shows a preferred embodiment of the MIMO filter;

FIG. 14 shows a conceptual organization of the MIMO filter of FIG. 13;

FIG. 15 shows a simplified view of the MIMO filter of FIG. 14; and

FIG. 16 shows an implementation of the filter of FIG. 2.

### DETAILED DESCRIPTION OF THE PREFERRED EMBODIMENT

In a typical digital signal proceessing system, a signal is acquired from an antenna and is sampled by an analog to digital converter (ADC). Then a digital downconverter (DDC) is used to prepare the signal data for a digital signal processor (DSP). The DDC first effects a frequency shift, then filters and then discards samples, passing only part of the signal on to the DSP.

FIG. 3 shows the frequency spectrum of a signal which is input to the DDC. The signal has been real sampled at Fs, and therefore, the signal of interest is in the range [0,Fs/2]. Outside of this range, the signal consists of aliases of the signal of interest.

The first stage of the DDC shifts the signal of interest to baseband (0 Hz), as shown in FIG. 4, by multiplying the incoming stream of samples by a complex sinusoid: e^{-j2πiFs/4}. Because the signal is multiplied by a complex number, the result is also complex. As a result, useful information is contained in the negative frequencies.

Useful information is available in the range [−Fs/2,Fs/2] but the signal of interest only takes up the range [−Fs/4,Fs/4]. Therefore, the sampling rate can be reduced by half. One way to reduce the sampling rate is to discard every other sample. The effect of doing this in the frequency domain, however would be to overlay the aliases onto the signal of interest. Therefore, before discarding every other sample, the signal should be low-pass filtered to remove the aliases which would interfere with the signal of interest.

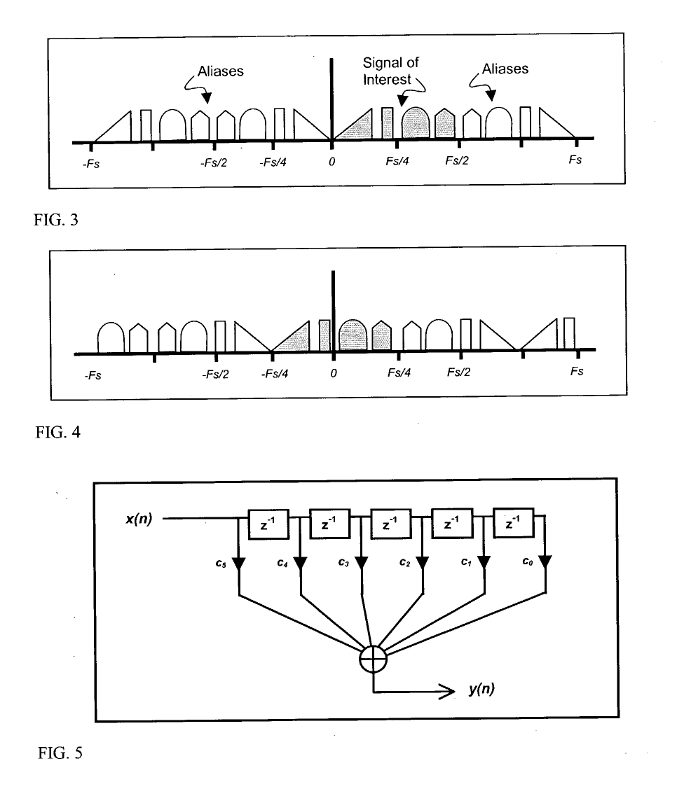

A Finite Impulse Response (FIR) filter is mathematically expressed as y(n)=Σᵢcᵢx(n−i), n=0, 1, 2 . . . number of samples, and i=0, 1, to the number of coefficients, and can be diagrammatically expressed with a combination of delay elements (z⁻¹) and multipliers (arrow). FIG. 5 shows a simple direct-form FIR filter with 6 taps that could be used to low-pass filter the input signal x(n) to remove the unwanted aliases. An FIR filter effectively implements a convolution in the time domain (which is a multiplication in the frequency domain). Thus the frequency response of the filter is defined roughly by the Fourier transform of the coefficients cᵢ.

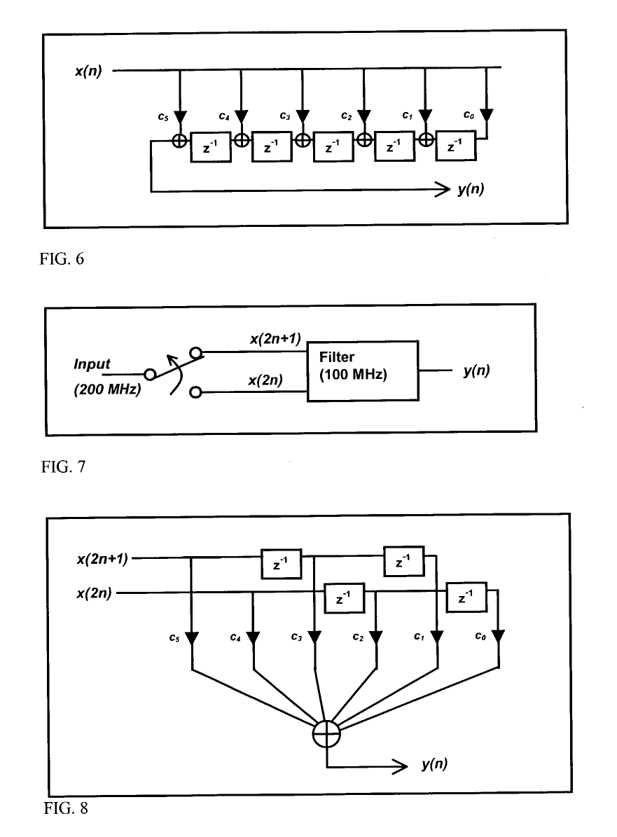

FIG. 6 shows an equivalent way of constructing the FIR filter, called a transpose-form FIR filter. In a transpose-form filter, all the multiplications are performed on the current input (not delayed versions of it, as in the direct-form filter).

In the typical implementation of a DDC, samples from the output of the filter are discarded. It is wasteful to calculate something which will be discarded. For example, if the input stream was arriving at 200 MSPS (million samples per second), the filter would calculate 200 million outputs per second, even though only 100 million outputs are actually used.

It is better to run the filter at the same rate as the output, as shown in FIG. 7. The input is multiplexed onto two lines going into the filter. Thus, the filter calculates a new output for each two inputs. It is then no longer necessary to discard outputs since they were never calculated.

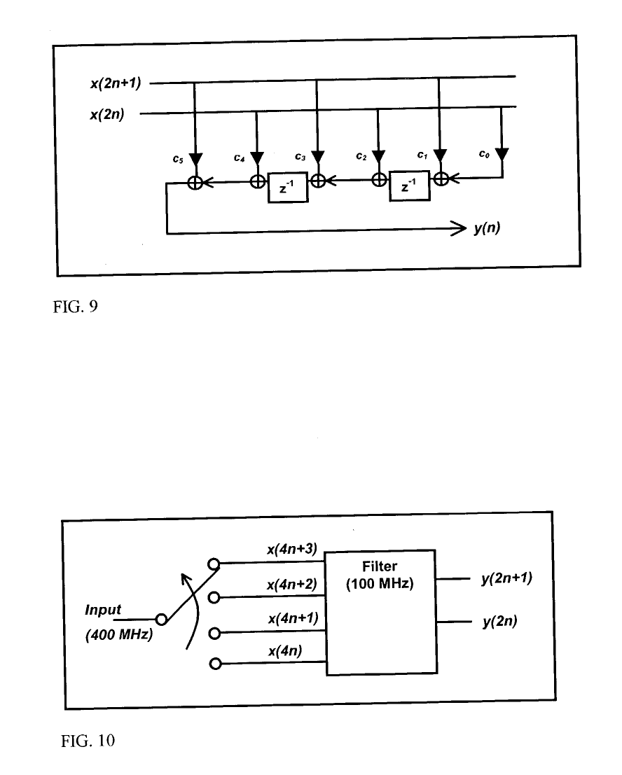

FIGS. 8 and 9 show the structure of the direct-form and transpose-form filters running at the output rate. Comparing them with FIGS. 5 and 6 show them to be equivalent to calculating every output and throwing outputs away. Favorably, the filters can run at a lower speed.

What happens when the input sample stream is coming in faster than the filter can process it? For example, the input samples are arriving at 400 MSPS, but the multipliers in the filter can run at a maximum rate of 100 MHz. If decimating by 2 (i.e. discarding every other sample), an output stream of 200 MSPS is needed, but the filter cannot run that fast. If the filter is running at its limit of 100 MHz, we need to accept 4 input samples and generate 2 output samples per clock, as shown in FIG. 10.

To implement such a filter, take a plurality of MISO (multiple input, single output) filters (see FIGS. 5 and 6 for the decimate-by-2 case). As shown in FIG. 11, two identical MISO decimate-by-4 filters are configured in parallel (sub-filters A and B) with the inputs to those sub-filters are staggered by two samples, to create a MIMO (multiple input, multiple output) filter.

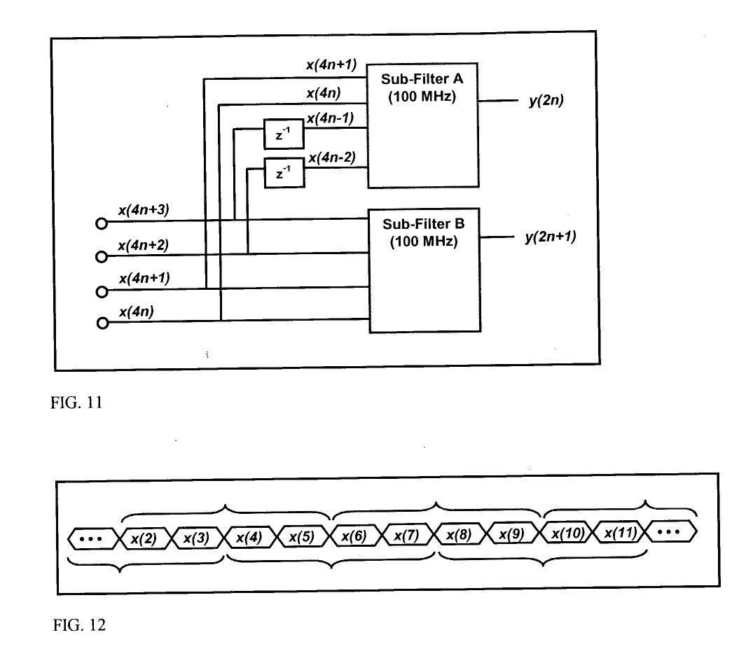

The inputs provided to the two sub-filters are shown in FIG. 12. Sub-filter A will receive (x(2),x(3),x(4),x(5)) followed by (x(6),x(7),x(8),x(9)), while sub-filter B will receive (x(4),x(5),x(6),x(7)) followed by (x(8),x(9),x(10),x(11)).

Generally, if it is desired to decimate-by-M, then a plurality of (N/M) decimate-by-N sub-filters are required in parallel, with the inputs to each sub-filter staggered or out of phase by M samples, where N is a multiple of M.

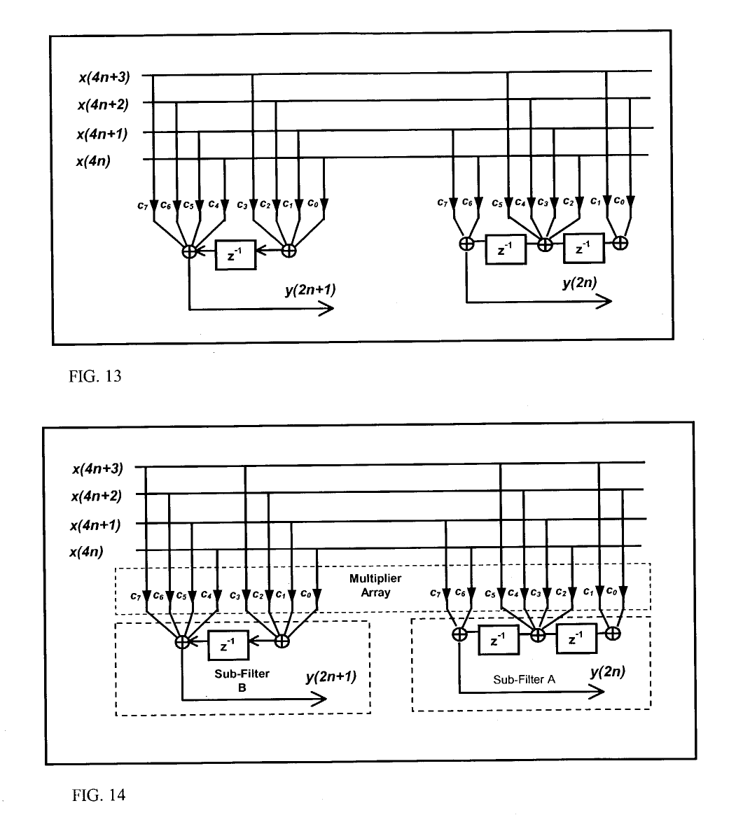

FIG. 13 is an implementation of the MIMO filter of FIG. 11. It uses transpose-form for both sub-filters, and the delay elements used to stagger the inputs have been pushed through the multipliers and adders. Expanding this filter to include more coefficients is effected by simple design.

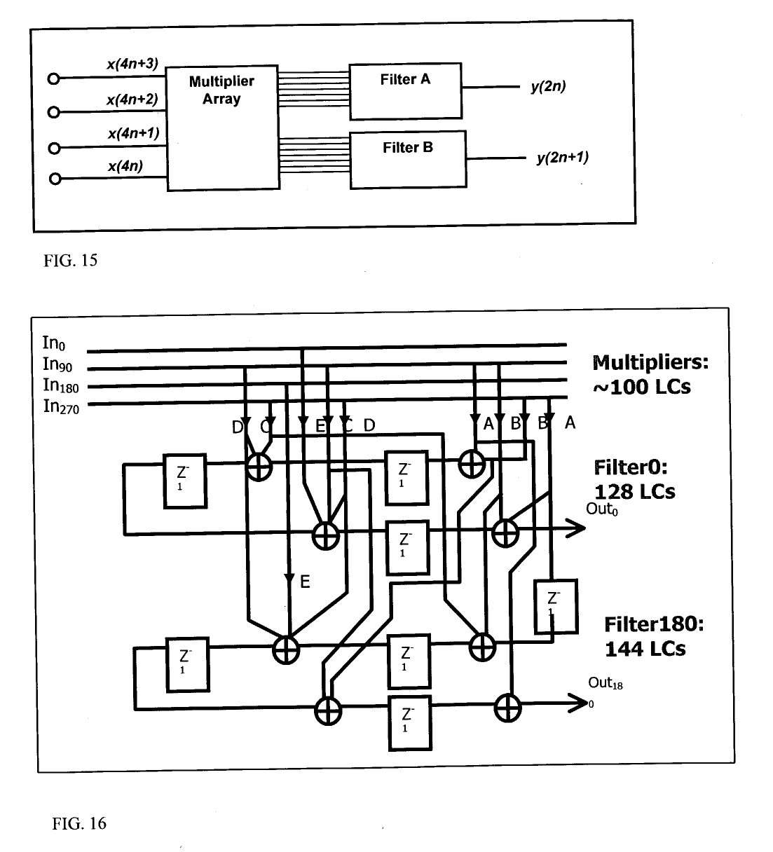

The major advantage to this structure is that it can be divided up into a multiplier array and the filter structures, as shown in FIGS. 14 and 15.

Because the multiplier array generates all of its products from the input values and fixed coefficients, huge optimizations can be made in the multiplier structures.

Table 1 shows a list of the products the multiplier array must calculate.

TABLE 1
Required products

| | Sub-Filter A | | | | Sub-Filter B | | | | |
|---|---|---|---|---|---|---|---|---|---|
| x(4n) | c₀ | c₄ | c₈ | c₁₂ | | c₂ | c₆ | c₁₀ | c₁₄ |
| x(4n + 1) | c₁ | c₅ | c₉ | c₁₃ | | c₃ | c₇ | c₁₁ | c₁₅ |
| x(4n + 2) | c₂ | c₆ | c₁₀ | c₁₄ | c₀ | c₄ | c₈ | c₁₂ | |
| x(4n + 3) | c₃ | c₇ | c₁₁ | c₁₅ | c₁ | c₅ | c₉ | c₁₃ | |

According to Table 1, the multiplier array must generate products for the multiplication of x(4n), for example, by c₀, c₄, c₈, c₁₂, c₂, c₆, c₁₀ and c₁₄. Because the input value (x(4n)) is the same, partial products can be shared. Selection of coefficients can be optimized to reduce the complexity of the multipliers. For example, if c₀ was 34 and c₄ was 181 (=128+34), then the partial product of 34*x(4n) can be shared.

When the filter coefficients are symmetric, as seen in Table 2, many of the products can be shared among the two sub-filters. Even more optimal is using a half-band symmetric filter (in which every second coefficient is 0), as seen in Table 3.

TABLE 2
Required products with symmetric coefficients

| | Sub-Filter A | | | | Sub-Filter B | | | | |
|---|---|---|---|---|---|---|---|---|---|
| x(4n) | c₀ | c₄ | c₆ | c₂ | | c₂ | c₆ | c₄ | c₀ |
| x(4n + 1) | c₁ | c₅ | c₅ | c₁ | | c₃ | c₇ | c₃ | |
| x(4n + 2) | c₂ | c₆ | c₄ | c₀ | c₀ | c₄ | c₆ | c₂ | |
| x(4n + 3) | c₃ | c₇ | c₃ | | c₁ | c₅ | c₅ | c₁ | |

TABLE 3
Required products with half-band symmetric coefficients

| | Sub-Filter A | | | | Sub-Filter B | | | | |
|---|---|---|---|---|---|---|---|---|---|
| x(4n) | c₀ | c₄ | c₆ | c₂ | | c₂ | c₆ | c₄ | c₀ |
| x(4n + 1) | 0 | 0 | 0 | 0 | | 0 | c₇ | 0 | |
| x(4n + 2) | c₂ | c₆ | c₄ | c₀ | c₀ | c₄ | c₆ | c₂ | |
| x(4n + 3) | 0 | c₇ | 0 | | 0 | 0 | 0 | 0 | |

In the preferred embodiment, each of the decimate-by-N sub-filters are of the half-band type, and are implemented in the transposed form. This allows the multipliers and coefficients to be shared among all (N/M) sub-filters.

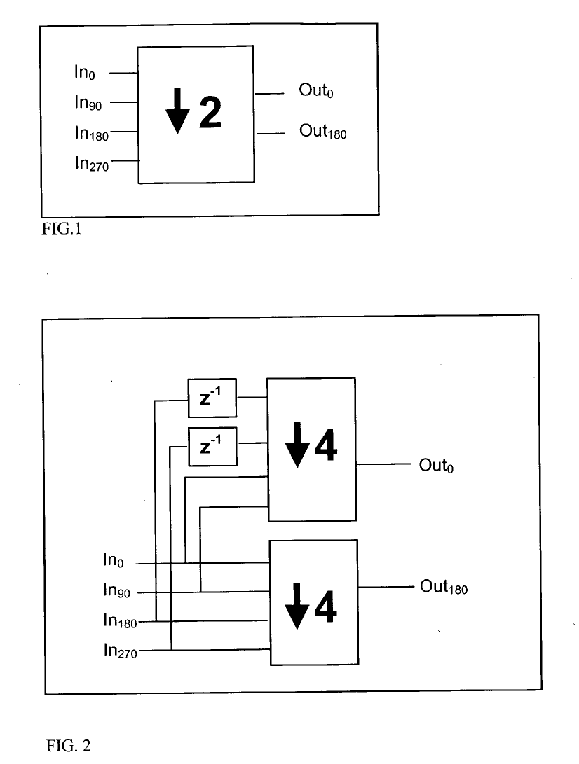

FIG. 16 show the implementation of the filter shown in FIG. 2, as a 4-input decimate-by-2 filter whose sub-filters share the following 9-tap half-band coefficients:

Coefficients

| | |
|---|---|
| 0.0000000 | |
| −0.0013733 | (A) |
| 0.0000000 | |
| 0.0138549 | (B) |
| 0.0000000 | |
| −0.0636597 | (C) |
| 0.0000000 | |
| 0.3012085 | (D) |
| 0.5000000 | (E) |
| 0.3012085 | |
| 0.0000000 | |
| −0.0636597 | |
| 0.0000000 | |
| 0.0138549 | |
| 0.0000000 | |
| −0.0013733 | |
| 0.0000000 | |

This embodiment requires less than 400 logic cells (LCs) in a common field programmable gate array.

Thus it is seen that the coefficients cᵢ and multipliers can be shared between the constituent sub-filters, and several optimizations can be made by using half-band filter coefficients, where every second coefficient is 0.

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

We claim:

1. A method of multiple input-multiple output digital filtering though decimate-by-M decimation comprising the steps of:
(a) providing in parallel, a plurality of (N/M) decimate-by-N sub-filters; and
(b) staggering the inputs to each said sub-filter to be out of phase by M samples, where N is a multiple of M.

2. The method of claim 1, wherein said sub-filters are implemented in FIR transpose-form and said sub-filters share multipliers.

3. The method of claim 2, wherein said sub-filters share intermediate products in the process effected by said multipliers.

4. A decimate-by-M filter comprising:
(a) a plurality of (N/M) decimate-by-N sub-filters configured in parallel; and
(b) a plurality of inputs into said sub-filters where said inputs are out of phase from each other by M samples, and N is a multiple of M.

5. The filter of claim 4 wherein said sub-filters are implemented in FIR transpose form and share multipliers.

6. The filter of claim 5 wherein said sub-filters share intermediate products in the process effected by said multipliers.

7. A digital filtering method for decimating by M, comprising the steps of:
(a) sampling input signal x(n) at input sampling frequency to create a plurality of samples;
(c) staggering said samples to be out of phase by M samples;
(b) multiplying said samples with a plurality of coefficients to obtain output signal y(n), at a frequency less than said input sampling frequency;
where said coefficients are obtained and said multiplication are performed according to the transpose form of a FIR.
